(19) United States
(12) Patent Application Publication
(10) Pub. No.: US 2012/0200786 A1
(43) Pub. Date: Aug. 9, 2012

(54) LIGHTING DEVICE, DISPLAY DEVICE AND TELEVISION RECEIVER

(75) Inventor: Daisuke Kamata, Osaka-shi (JP)

(73) Assignee: SHARP KABUSHIKI KAISHA, Osaka-shi, Osaka (JP)

(21) Appl. No.: 13/501,128

(22) PCT Filed: Sep. 9, 2010
(86) PCT No.: PCT/JP2010/065481

§ 371 Date: Apr. 10, 2012

(30) Foreign Application Priority Data
Oct. 20, 2009 (JP) 2009-241304

(51) Int. Cl. G02F 1/1335; F21S 4/00; H04N 3/14; F21V 5/04; G09F 13/04; F21V 21/00; F21V 7/00

(52) U.S. Cl. 348/790; 362/249.01; 362/225; 362/219; 362/247; 362/249.06; 362/246; 362/97.1; 349/61; 348/E03.016

(57) ABSTRACT

The present invention has an object to provide a lighting device enabled to reduce a cost. A plurality of light source units U, formed by arranging a plurality of light source modules 30A on an LED board 18, arranged parallel to each other constitutes a backlight unit 12. In the backlight unit 12, the plurality of light source modules 30 in one LED board 18 includes a light source module 30A and a light source module 30B. The light source module 30A has an optical directivity directing light therefrom into a first direction in a plan view. The first direction is along an arrangement direction of the light source units U. The light source module 30B has an optical directivity directing light therefrom into a second direction opposite to the first direction in a plan view.

### TECHNICAL FIELD

The present invention relates to a lighting device, a display device and a television receiver.

### BACKGROUND ART

Recently, as image display devices such as a television receiver, conventional devices using cathode-ray tubes have been increasingly replaced by thin display devices to which thin display elements, such as a liquid crystal panel and a plasma display panel, are applied. In a case where a liquid crystal panel is used as a display element, the liquid crystal panel does not emit light and therefore requires a backlight unit separately as a lighting device. Patent Document 1 below describes one example of a backlight unit. In a backlight unit described in Patent Document 1, a light source unit is formed by arranging a plurality of LEDs (light sources) in a straight line on a rectangular board, and the plurality of light source units thus formed is arranged into a two-dimensional structure.

Patent Document 1: Japanese Unexamined Patent Publication No. 2007-317423

### Problem to be Solved by the Invention

Cost reduction of a backlight unit has been required in order to provide a lower-priced backlight unit. For the cost reduction, it is effective to reduce costs of components of the backlight unit, especially, a cost of the plurality of light source units to be arranged. Conventional technologies have room for improvement in this respect.

### DISCLOSURE OF THE PRESENT INVENTION

The present invention was made in view of the foregoing circumstances. An object of the present invention is to provide a lighting device enabled to reduce a cost. The present invention also has an object to prove a display device and a television receiver, which include the lighting devices.

### Means for Solving the Problem

In order to solve the above problem, a lighting device includes a plurality of light source units arranged parallel to each other. Each unit includes a plurality of light sources arranged on a board. The plurality of light sources on the board includes first light sources and second light sources. The first light sources have an optical directivity directing light therefrom into a first direction in a plan view. The first direction is along an arrangement direction of the light source units. The second light sources have an optical directivity directing light therefrom into a second direction opposite to the first direction in a plan view.

According to the present invention, the first light sources and the second light sources have optical directivities directing light therefrom into directions opposite to each other. Both the first and second light sources are arranged in one board to irradiate both sides in a direction along the arrangement direction of the light source units. This makes it possible to enlarge a range irradiated with light by the light source units and to enlarge arrangement intervals of the light source units, and to make brightness even, as compared to a configuration using light source units each including only light sources having the same optical directivity directing light therefrom into a single direction (e.g., a direction along a direction in which light is emitted from the lighting device). As a result, even in a configuration where even brightness distribution is required, the number of the light source units can be reduced. Therefore, the present invention can reduce material costs associated with the light source units and also reduce labor cost associated with the work for attaching the light source units. Thus, the present invention can reduce total cost significantly.

### BRIEF DESCRIPTION OF THE DRAWINGS

FIG. 1 is an exploded perspective view showing a schematic configuration of a television receiver according to a first embodiment of the present invention;

FIG. 2 is an exploded perspective view showing a schematic configuration of a liquid crystal display device included in the television receiver shown in FIG. 1;

FIG. 3 is a plan view showing the configuration of a backlight unit included in the liquid crystal display device shown in FIG. 2;

FIG. 4 is a cross-sectional view (a cross-sectional view cut along the line A-A of FIG. 3) showing a sectional configuration of the liquid crystal display device of FIG. 2 taken along a direction along the short sides thereof;

FIG. 5 is an enlarged cross-sectional view showing the enlarged vicinity of light source modules in FIG. 4;

FIG. 6 is an enlarged cross-sectional view showing the enlarged vicinity of a light source unit in FIG. 3;

FIG. 7 is a plan view showing a comparative example of a backlight unit;

FIG. 8 is an enlarged view showing the enlarged vicinity of a light source unit in FIG. 7;

FIG. 9 is a plan view showing a backlight unit according to a second embodiment of the present invention;

FIG. 10 is a plan view showing a backlight unit according to a third embodiment of the present invention;

FIG. 11 is a plan view showing a backlight unit according to a fourth embodiment of the present invention; and

FIG. 12 is a plan view showing a backlight unit according to a fifth embodiment of the present invention.

### BEST MODE FOR CARRYING OUT THE INVENTION

### First Embodiment

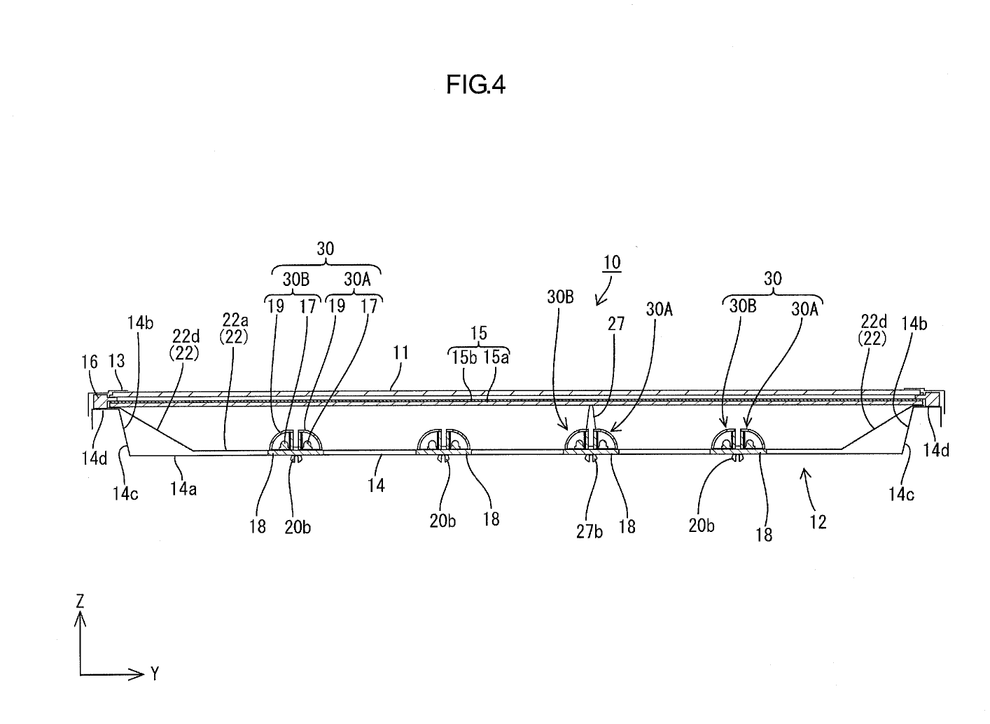

A first embodiment of the present invention is described with reference to the drawings. Some of the drawings show the X-axis, the Y-axis and the Z-axis, and those axial directions correspond to the direction indicated in respective drawings. Additionally, the upper side shown in FIG. 4 represents the front side, and the lower side shown in FIG. 4 represents the back side.

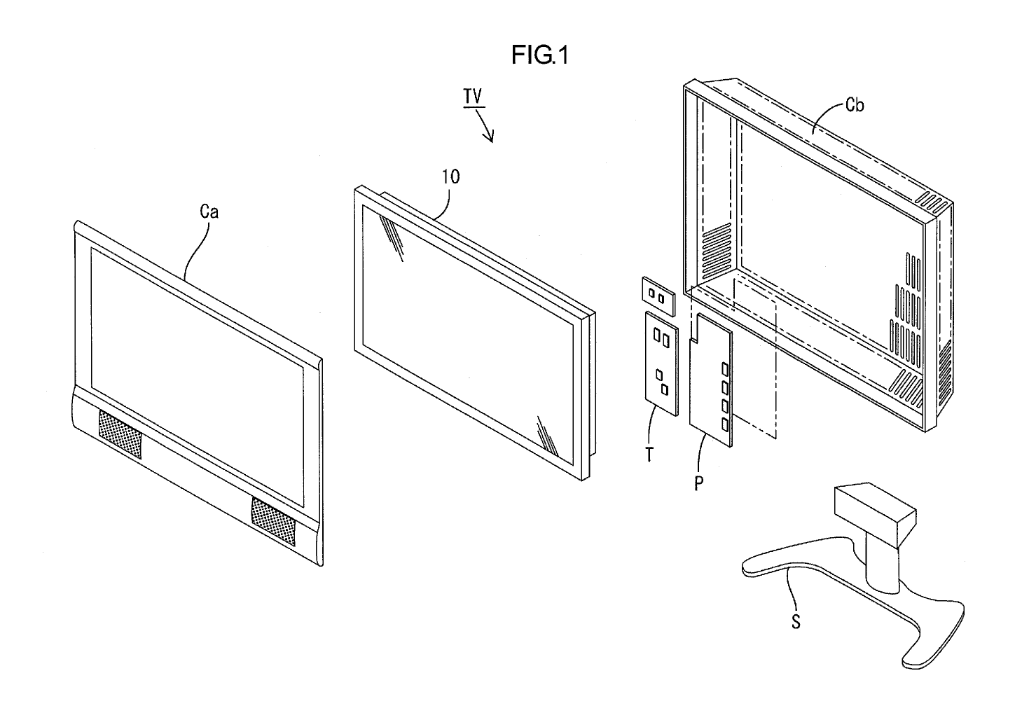

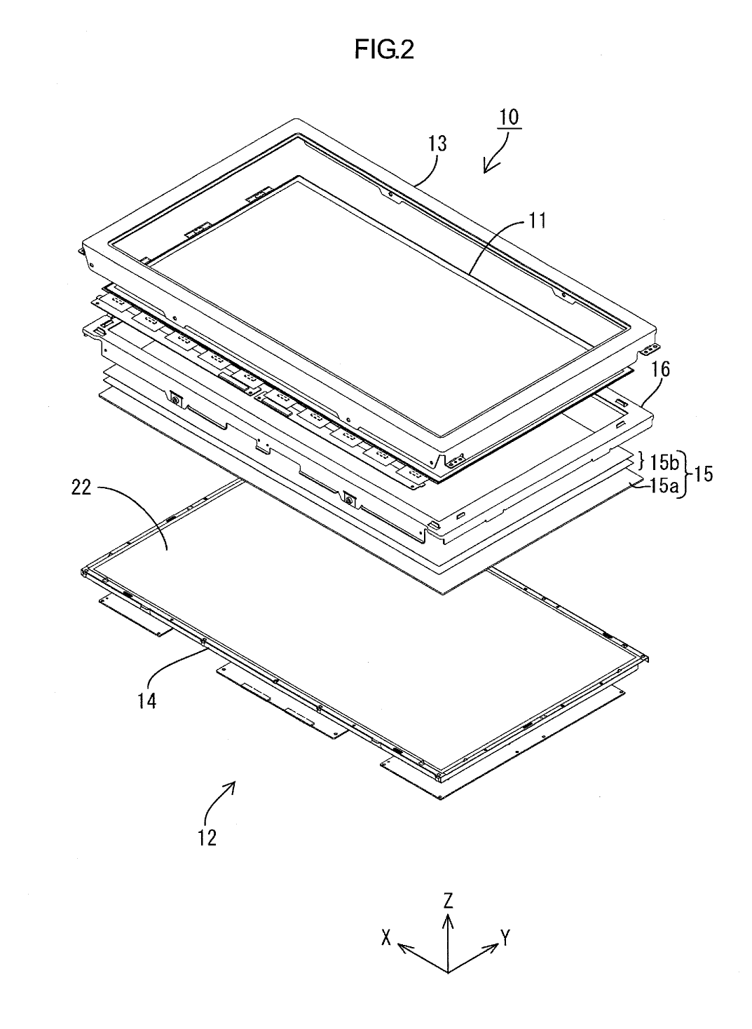

As shown in FIG. 1, a television receiver TV according to the present embodiment includes a liquid crystal display device 10, front and back cabinets Ca and Cb housing and sandwiching the liquid crystal display device 10, a power supply P, a tuner T, and a stand S. The liquid crystal display device 10 (a display device) as a whole has a horizontally elongated square shape (a rectangular shape), and is housed in a stand-up state. As shown in FIG. 2, this liquid crystal display device 10 includes a liquid crystal panel 11 as a display panel, and a backlight unit 12 (a lighting device) as an external light source. These components are integrally held by means of a frame-like bezel 13 and the like. This embodiment shows, as an example, the liquid crystal display device 10 having a screen size of 42 inches, and an aspect ratio of 16:9.

Next, the liquid crystal panel 11 and the backlight unit 12 constituting the liquid crystal display device 10 are described sequentially. The liquid crystal panel 11 (a display panel) has a rectangular shape in a plan view, and is formed into a configuration obtained by joining a pair of glass substrates with a predetermined gap and enclosing liquid crystal therebetween. One of the glass substrates is provided with switching components (e.g., TFTs) each connected to a source line and a gate line which are orthogonal to each other, pixel electrodes connected to these switching components, an alignment film, and the like. The other glass substrate is provided with a color filter on which color sections each corresponding to R (red), G (green), B (blue) or the like are arranged in a predetermined pattern, a counter electrode, an alignment film, and the like. Note that polarizing plates are arranged on the outer sides of the two substrates. A control board not shown is connected to the liquid crystal panel 11, thereby providing a configuration to control display on the liquid crystal panel 11.

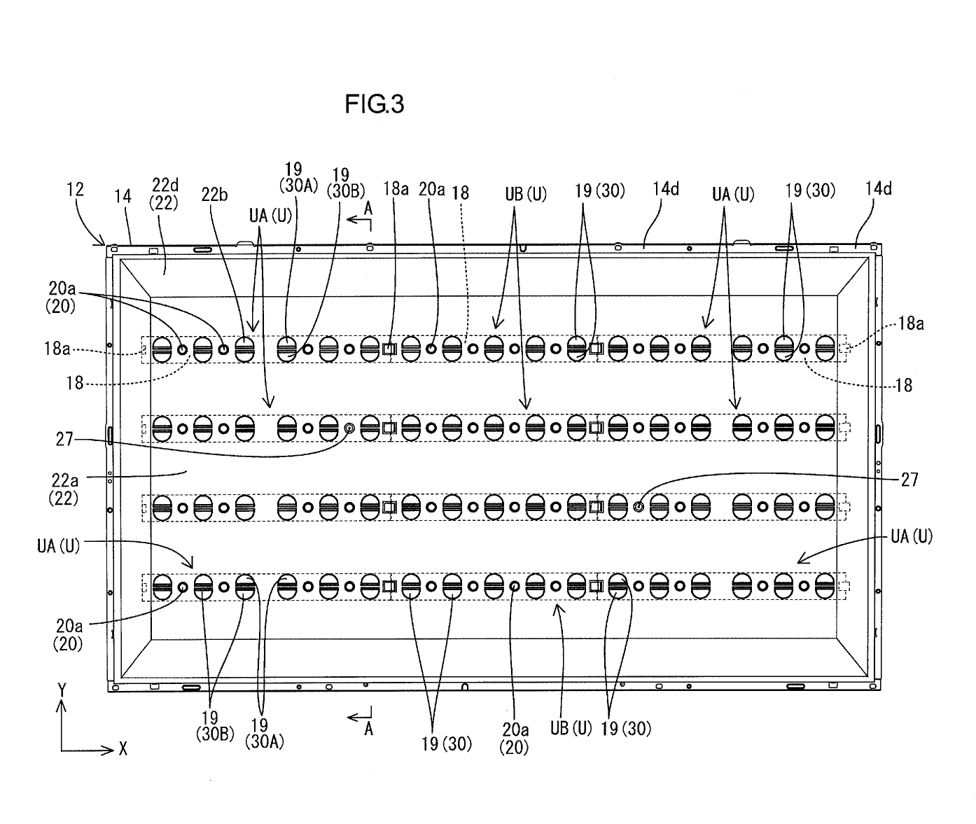

Next, the backlight unit 12 is described in detail. As shown in FIGS. 3 and 4, the backlight unit 12 includes: a chassis 14 having an opening 14b on the light emitting surface side (the liquid crystal panel 11 side) thereof and having a substantially box-like shape; a group of optical members 15 (a diffuser plate 15a, and a plurality of optical sheets 15b arranged between the diffuser plate 15a and the liquid crystal panel 11) arranged so as to cover the opening 14b of the chassis 14; a frame 16 arranged along an outer edge portion of the chassis 14, and supporting outer edge portions of the optical members 15 by sandwiching with the chassis 14; and an chassis-side reflection sheet 22 configured to reflect light having entered into the chassis 14 toward the optical members 15 side. Further, light source units U having LEDs 17 (light emitting diodes) as light sources and the like are housed inside the chassis 14. Note that in the backlight unit 12, the side closer to the optical members 15 (front side) than the light source units U is referred to as a light emitting side. Each component of the backlight unit 12 is described below in detail.

The chassis 14 is made of a metal, and, as shown in FIGS. 3 and 4, includes: a bottom plate 14a having a rectangular shape like the liquid crystal panel 11; side plates 14c rising from outer edges of each side of the bottom plate 14a; and receiving plates 14d projecting outward from the rising ends of the side plates 14c. The chassis 14 as a whole has a shallow, substantially box-like shape (substantially shallow pan shape) opened toward the front side. The long side direction of the chassis 14 is aligned with the X-axis direction (the horizontal direction), and the short side direction thereof is aligned with the Y-axis direction (the vertical direction). The receiving plates 14d in the chassis 14 are configured such that the frame 16 and the below described optical members 15 are mountable thereon from the front side. The receiving plates 14d have the frame 16 screwed thereto.

As shown in FIG. 2, the optical members 15 have a horizontally elongated square shape (a rectangular shape) in a plan view like the liquid crystal panel 11 and the chassis 14. As shown in FIG. 4, by having the outer edge portions thereof mounted on the receiving plates 14d, the optical members 15 are interposed between the liquid crystal panel 11 and the light source units U so as to cover the opening 14b of the chassis 14. The optical members 15 include the diffuser plate 15a arranged on the back side (the side of the light source units U, the side opposite to the light emitting side), and the optical sheets 15b arranged on the front side (the side of the liquid crystal panel 11; the light emitting side). The diffuser plate 15a has a configuration obtained by dispersing a large number of diffusing particles in a substantially transparent base substrate made of resin and having a predetermined thickness, and has the function of diffusing transmitted light.

The optical sheets 15b have a sheet-like shape having a plate thickness thinner than that of the diffuser plate 15a, and have, for example, two layers arranged by being laminated together. Specific kinds of optical sheets 15b include a diffuser sheet, a lens sheet and a reflection type polarizing sheet. The optical sheets may be appropriately selected among these examples. Additionally, as shown in FIGS. 3 and 4, support pins 27 supporting the optical member 15 from the back side thereof are attached inside the chassis 14. The support pins 27 are made of synthetic resin (e.g., made of polycarbonate), and the overall surfaces thereof appear in a whitish color, such as a while color, which has high light reflectance. The support pins 27 have insertion portions 27b protruding to the back side. The support pins 27 are attached to the chassis 14 with insertion portions 27b inserted through the bottom plate 14a of the chassis 14 and caught by the bottom plate 14a from the back side thereof.

As shown in FIG. 2, the frame 16 has a frame-like shape conforming to the outer-circumferential portions of the liquid crystal panel 11 and the optical members 15. This frame 16 is configured such that the outer edge portions of the optical members 15 may be interposed and held between this frame 16 and each of the receiving plates 14d (FIG. 4). This frame 16 is also configured such that an outer edge portion of the liquid crystal panel 11 may be received thereby from the back side and may be interposed and held between this frame 16 and the bezel 13 which is arranged on the front side of the liquid crystal panel 11 (FIG. 4).

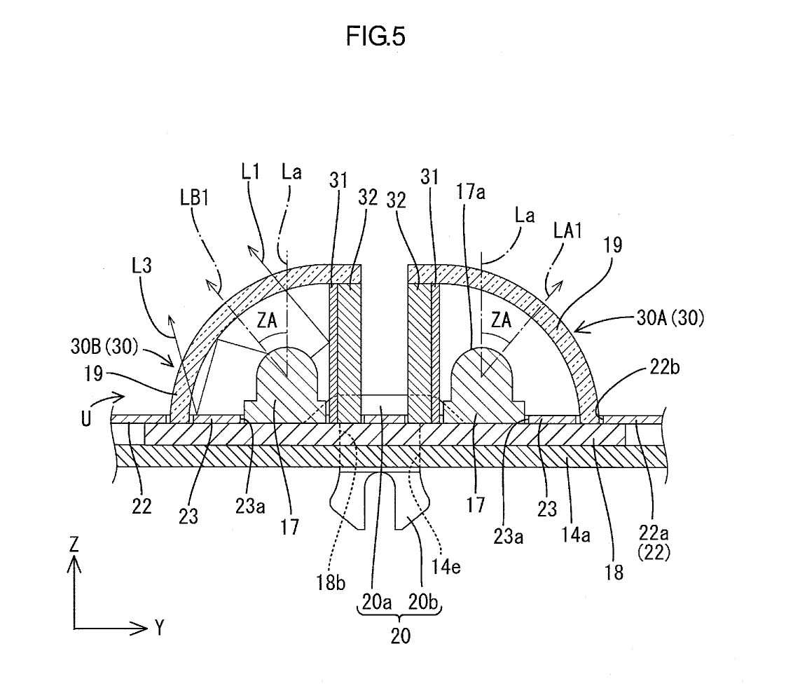

The chassis-side reflection sheet 22 is made of synthetic resin, and the surface thereof appears in a white color, which has high light reflectance. As shown in FIG. 4, the chassis-side reflection sheet 22 is provided so as to extend along the inner surface of the chassis 14. The chassis-side reflection sheet 22 includes a body portion 22a and a slope portion 22d. The body portion 22a extends along the bottom plate 14a of the chassis 14. The most of the middle part of the chassis-side reflection sheet 22 corresponds to the body portion 22a. The slope portion 22d is a slope. The body portion 22a has lens insertion holes 22b which penetrate the body portion 22a at positions corresponding to diffuser lenses 19 (to be described below) included in the light source units U arranged inside the chassis 14 (refer to FIG. 5). Each of the lens insertion holes 22b has, for example, the same shape (a substantially semilunar shape in the case of this embodiment) as the diffuser lenses 19 in a plan view, whereby each of the diffuser lenses 19 is allowed to be inserted through a corresponding one of the lens insertion holes 22b. This makes it possible to have each of the diffuser lenses projecting and exposed toward the front side from the chassis-side reflection sheet 22.

Further, as shown in FIG. 4, an outer-circumferential portion of the chassis-side reflection sheet 22 is rising so as to cover the side plates 14c and the receiving plates 14d of the chassis 14, and a portion thereof mounted on the receiving plates 14d is sandwiched between the chassis 14 and the optical member 15. The slope portion 22d connects the body portion 22a and the outer-circumferential portion (the portion mounted on the receiving plates 14d) within the chassis-side reflection sheet 22. This chassis-side reflection sheet 22 makes it possible to reflect light emitted by the LEDs 17 toward the optical members 15 side.

Next, the light source units U are described in detail. The light source units U include light source modules 30 (light sources), and an LED board 18 (a board) having the plurality of light source modules 30 arranged thereon. As shown in FIG. 3, the plurality of light source units U is arranged inside the chassis 14 in the X-axis direction and the Y-axis direction. In this context, inside the chassis 14, the light source units U are placed in a matrix arrangement (arranged in a matrix) in which rows correspond to the X-axis direction (the long side direction of the chassis 14 and the LED boards 18), columns correspond to the Y-axis direction (the short side direction of the chassis 14 and the LED boards 18). Specifically, in the chassis 14, the light source units U are arranged parallel to each other in the X-axis direction by three and the light source units U are arranged parallel to each other in the Y-axis direction by four. That is, this embodiment has twelve light source units U in total arranged on the chassis 14.

As shown in FIG. 3, the LED board 18 includes the plurality of light source modules 30 in the X-axis direction to from a column shape. Further, two light source modules 30 are arranged side by side in the Y-axis direction. As shown in FIG. 5, each of these light source modules 30 includes the LEDs 17 (light source body) emitting light, and support-portion side reflection sheets 31 (reflection portions). The specific configuration thereof is described later. In the present embodiment, the configuration uses two kinds of light source units U different in the number of the light source modules 30 in the X-axis direction. Specifically, as the light source units U, those (assigned a reference sign UA) having six of the light source modules 30 (consequently, six of the LEDs 17) arranged in each line along the X-axis direction (that is, each including the twelve light source modules 30 arranged in two lines each having the six modules), and the others (assigned a reference sign UB) each having five of the light source modules 30 (consequently, five of the LEDs 17) arranged in each line along the X-axis direction (that is, each including the ten light source modules 30 arranged in two lines each having the five modules) are used. The long side dimension of the LED board 18 in each of the light source units UA is set longer than the long side dimension of the LED board 18 in each of the light source units UB. Additionally, the light source units UA are arranged at both ends of the chassis 14 in the X-axis direction, and one light source units UB is arranged in the central position in the X-direction.

The LED boards 18 arranged parallel to each other along the X-axis direction as described above are electrically connected to one another by having adjacent connector portions 18a fitted in with each other. The connector portions 18a corresponding to both ends of the chassis 14 in the X-axis are electrically connected to a drive control circuit (not shown). Thus, the LEDs 17 of the light source modules 30 arranged on the LED boards 18 forming one row are connected in series. Therefore, collective control of turning on and off of the multiple LEDs 17 included in the one row is enabled by use of only one drive control circuit. As a result, cost reduction can be achieved. Note that, among the LED boards 18, although there are differences in length of the long sides or in the number of the light source modules 30 arranged thereon, there are substantially no differences in length of the short sides and in an arrangement pitch.

The following effect is obtained by adopting a method in which the plurality of kinds of the light source units U, different in the long side dimension and in the number of light source modules 30 arranged thereon, is thus prepared and used in combination as appropriate. For example, when the liquid crystal display devices 10 of various kinds different in screen size is manufactured, it can be easily dealt with by appropriately changing the combination (whether or not to use the light source units U, and the number of the light source units U in each of the kinds to be used) of the plurality of kinds of the light source units U with respect to each screen size. This allows the number of kinds of the light source units U to be much smaller than in a configuration where the light source units U are designed into different kinds which are dedicated for different screen sizes, and in each of which the long side dimension have the same length as the length of the chassis 14 with a corresponding one of the screen sizes (that is, a configuration where the number of kinds of the light source units should be equal to the number of different screen sizes). This enables reduction of the manufacturing cost. Additionally, in addition to the light source units U having five or six of the light source modules 30 arranged in the X-axis direction, the light source units U having the number of the light source modules 30 other than five or six arranged in the X-axis direction may be combined.

Next, components of the light source units U are described. Note that, although the present embodiment shows the light source unit UA having six of the light source modules 30 arranged thereon in the X-axis direction and the light source unit UB having five of the light source modules 30 arranged thereon in the X-axis direction as examples, these light source units UA and UB have the same configuration except that the number of the light source modules 30 arranged thereon. Therefore, only the light source units UA are described herein.

As shown in FIG. 3, each of the LED boards 18 has a base member having a rectangular shape (an elongated shape extending in the X-axis direction) in a plan view, and is housed inside the chassis 14 in a manner extending along the bottom plate 14a with long side direction and short side direction thereof aligned with the X-axis direction and the Y-axis direction, respectively. The base material of the LED board 18 is made of, for example, a metal such as an aluminum-based material as in the case of the chassis 14 and has a configuration obtained by forming a wiring pattern thereon with an insulating layer interposed therebetween, the wiring pattern being made of a metal film such as copper foil. Note that, for example, an insulating material such as ceramic may be used alternatively as a material used for the base member of the LED board 18. Alternatively, for example, material other than above may be used for the base member of the LED board 18, and include paper phenol (FR-1 or FR-2), glass epoxy (FR-4), and glass composites (CEM-3). Note that a material for the LED board 18 is not limited to the above described materials and may be selected as appropriate.

As shown in FIG. 3, in the LED board 18, a clip 20 fixing the LED board 18 to the chassis 14 is attached between each of the light source modules 30 along the X-axis direction. As shown in FIGS. 4 and 5, for example, the clip 20 is made of synthetic resin, and includes an attachment plate 20a running parallel to the LED board 18 and having a circular shape in a plan view, and an insertion portion 20b projecting from the attachment plate 20a toward the chassis 14 in the Z-axis direction. As shown in FIG. 5, the insertion portion 20b penetrates both of a through hole 18b formed in the LED board 18 and a through hole 14e formed in the bottom plate 14a of the chassis 14, thereby being attachable to the chassis 14. The LED board 18 is thus fixed to the chassis 14 by being interposed and held between the attachment plate 20a of the clip 20 and the chassis 14. Also, as shown in FIG. 3, the connector portions 18a are provided in both end portions of the LED board 18 in the long side direction.

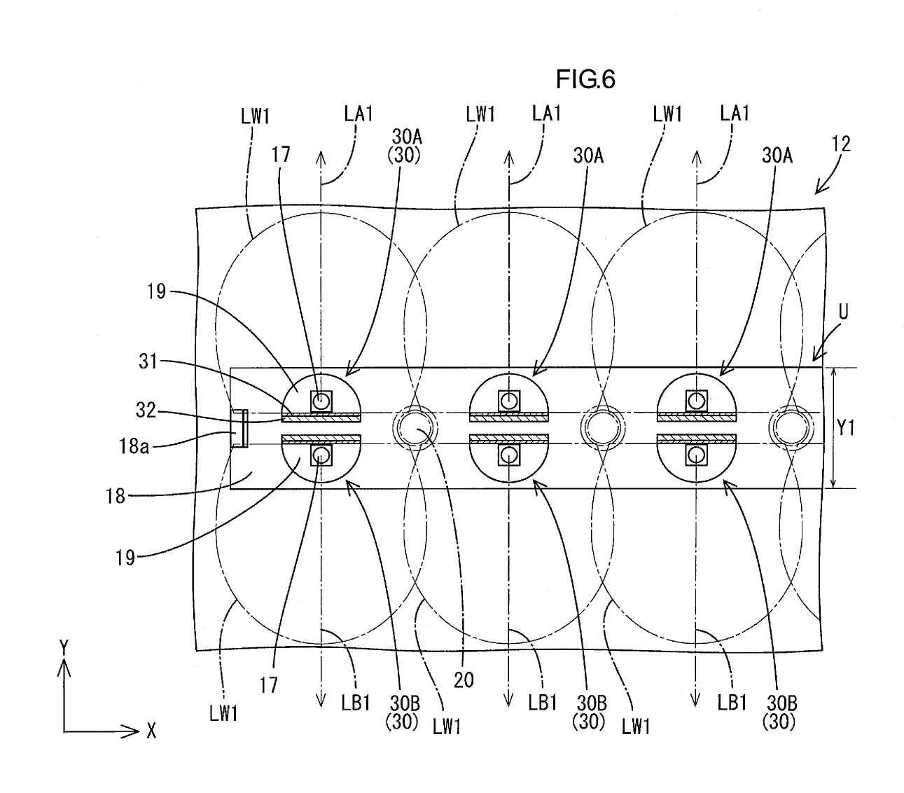

Next, the light source modules 30 are described in detail. As described above, the LED board 18 has two light source modules 30 arranged on the Y-axis, and, in a plan view, the light source modules 30 arranged in one of these two lines have directivities different from those arranged in the other line. That is, in any one of the light source units U (that is, in one LED boards 18), the plurality of light source modules 30 includes a light source module 30A (a first light source) located in the upper part in FIG. 6, and a light source module 30B located in the lower part in FIG. 6. That is, the plurality of the light source modules 30A is arranged in the X-axis, the plurality of the light source modules 30B are arranged in parallel with the line of the light source modules 30A.

The light source modules 30A and the light source modules 30B have the same configuration, and are set so as to be oriented in different directions when being installed. Specifically, as shown in FIG. 6, the light source module 30B is attached in a state of being turned at 180 degrees to the light source module 30A in a plan view, and a support portion 32 (described below) of the light source module 30A and a support portion 32 of the light source module 30B are arranged so as to face with each other.

The LED 17 is a kind of a point light source, which has a point-like shape in a plan view. The LED 17 is formed in a configuration obtained by, with a resin material, sealing an LED chip on a board portion to be adhered to the LED board 18. The LED chips to be mounted on the board portion are configured to have the same dominant wavelength. Specifically, those that emit light in one color, which is blue, are used as the LED chips. On the other hand, in the resin material used for sealing the LED chips, a phosphor is blended in a dispersed manner. The phosphor converts the blue light emitted from the LED chips into white light. The LEDs 17 are thereby enabled to emit white light.

The LEDs 17 are configured as a so-called top-type LED whose surface (surface facing the front side) opposite to the mounting surface with respect to the LED board 18 serves as a light emitting surface 17a. The optical axes La of the LEDs 17 are set substantially in the same direction as the Z-axis direction (a direction orthogonal to the main plate surfaces of the liquid crystal panel 11 and the optical members 15). Note that, while light emitted from the LEDs 17 three-dimensionally and relatively radially spreads in a range of a predetermined angle with the optical axis La as the center, the directivity of the light is known to be higher than light emitted from a cold cathode tube or the like. That is, the emission intensity of the LED 17 is outstandingly high along the optical axis La, and shows a distribution in terms of angle where the emission intensity tends to steeply decrease as the angle of light with respect to the optical axis La increases.

The LED 17 is surface-mounted on the surface facing the front side (the surface facing the optical members 15) of the plate surfaces of the LED board 18. The plurality of LEDs 17 is arranged in a straight line along the long side direction (the X-axis direction) of the LED board 18 so as to correspond to the respective light source modules 30, and is connected to one another in series via the wiring pattern (not shown) formed on the LED board 18. Further, the LEDs 17 are arranged at approximately uniform pitches. That is, the LEDs 17 are arranged substantially at regular intervals. Note that the LEDs 17 may be arranged at irregular intervals. For example, intervals of the LEDs 17 are relatively smaller in a portion relatively close to the center in the arrangement direction, and intervals of the LEDs 17 are relatively larger in a portion close to the ends in the arrangement direction. Alternatively, the total number of LEDs 17 may be reduced by setting intervals of the LEDs 17 larger partially.

In the light source module 30, the support portions 32 are provided so as to stand from the LED board 18 at the inner side of the width direction (the Y-axis direction) of the LEDs 17, as shown in FIG. 5. Each of the support portions 32 has, for example, a plate shape extended along the X-axis direction and the Z-axis direction. The width of the support portion 32 in the X-axis direction is set to be a length substantially equal to the width of the diffuser lenses 19 in the same direction. The surface of the support portion 32 outward (left and light direction in FIG. 5; up and down direction in FIG. 6) in a width direction (the Y-axis direction) of the LED 17 is arranged in the close vicinity of the LEDs 17, and the support-portion side reflection sheet 31 is arranged all over this surface. That is, in the light source module 30A, the reflecting surface of the support-portion side reflection sheet 31 faces the upper side (one side in a plan view) of FIG. 6, whereas, in the light source module 30B, the reflecting surface of the support-portion side reflection sheet 31 faces the lower side (the other side in a plan view) of FIG. 6.

As shown in FIG. 5, board side reflection sheets 23 are arranged on the surfaces at the front side of the LED boards 18, that is, the surfaces having the LEDs 17 mounted thereon. These board side reflection sheets 23 are extended along the LED boards 18 and have almost the same external shapes as the LED boards 18, namely, rectangular shapes in a plan view. That is, the board side reflection sheets 23 are arranged to almost overlap with the surfaces having the LEDs 17 mounted thereon. In other words, the board side reflection sheets 23 are configured to cover regions of the chassis 14 on which the chassis-side reflection sheet 22 is not arranged. Therefore, light (an arrow L3) reflected back toward the LED boards 18 by the diffuser lenses 19 (described below), and light heading into the lens insertion holes 22b from a space outside the diffuser lenses 19 are almost all returned toward and back into the diffuser lenses 19 by the board side reflection sheet 23. This increases efficiency in light utilization, and, as a result, increases brightness.

In other words, sufficient brightness is obtained even in a case where the number of the LEDs 17 to be installed is reduced for the cost reduction purpose. Additionally, LED insertion holes 23a through which the respective LEDs 17 can be inserted are formed in the board side reflection sheets 23 at positions overlapping with the respective LEDs 17 on the LED boards 18 in a plan view, as shown in FIG. 6. Note that, as in the case of the chassis-side reflection sheet 22, the support-portion side reflection sheet 31 and the board side reflection sheets 23 are made of synthetic resin, and the outer surfaces thereof appear in a white color having high light reflectance.

The diffuser lenses 19 are provided so as to cover the respective light source modules 30. The diffuser lens 19 has, for example, a quarter-spherical shape (a semicircular shape in a plan view), and is made of a synthetic resin material (for example, polycarbonate, acrylic or the like) that is substantially transparent (highly capable of light transmission) and has a refractive index higher than air. The diffuser lenses 19 are arranged so as to individually cover the respective LEDs 17 (as well as the light source module 30) from the front side. Specifically, the lower ends of the diffuser lenses 19 are attached to the LED boards 18, and the upper ends of the diffuser lenses 19 are supported by the upper surfaces (the front side surface) of the respective support portions 32, for example. This configuration enables light emitted from the LEDs 17 to be diffused through the diffuser lenses 19, whereby the directivity thereof is reduced. Therefore, even in a case where intervals between adjacent LEDs 17 are set relatively large, it is unlikely that regions therebetween are visually recognized as dark portions. This reduces the number of the LEDs 17 to be installed.

The structure of the present embodiment is given as described above, the operation and effect thereof are described next. The LEDs 17 are turned on when driving power is supplied to the LEDs 17 thereto by the drive control circuit. A predetermined image is displayed on the display surface of the liquid crystal panel 11 when image signals are supplied from a control board to the liquid crystal panel 11 at the same time as the LEDs 17 are turned on. In this context, as shown in FIG. 5, light emitted from the LEDs 17 inward in the width direction of the LED board 18 is reflected outward (an arrow L1) in the width direction of the LED board 18 (a first direction side) by the support-portion side reflection sheet 31. Consequently, light emitted from the light source modules 30 is given an optical directivity directing the light into an direction inclined outward in the width direction of the LED board 18 by an angle ZA (arrows LA1 and LB1 in FIG. 5) with respect to the Z-axis.

That is, as shown in FIG. 6, light emitted from the light source modules 30A has an optical directivity directing the light upward (the first direction along a direction in which the lines of the light source units U) in the Y-axis direction in a plan view. In other words, the optical axes of the light source modules 30A are arranged in the first direction along the arrangement direction of the light source units U. Additionally, light emitted from light source modules 30B has an optical directivity directing the light downward (a direction opposite to the first direction) in the Y-axis direction in a plan view. As a result, light is emitted from the light source units U, in a plan view, toward both sides of the boards with respect to a direction along the arrangement direction of the light source units U. Note that FIG. 6 schematically illustrates a range irradiated with light emitted from the light source modules 30 by using an alternate long and short dashed line LW1.

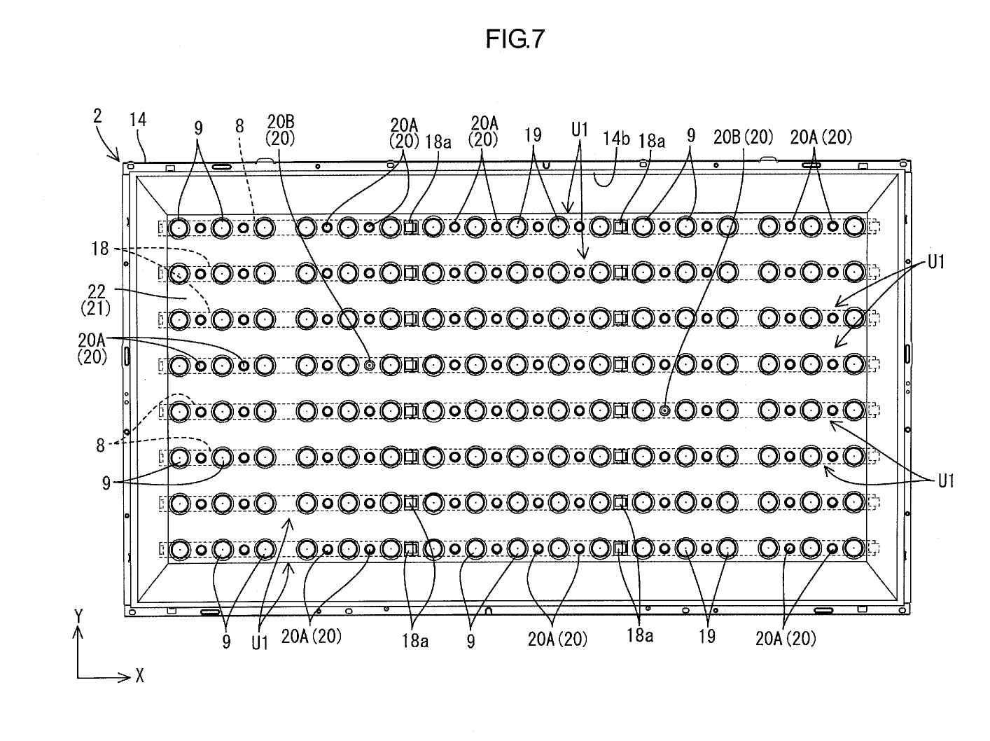

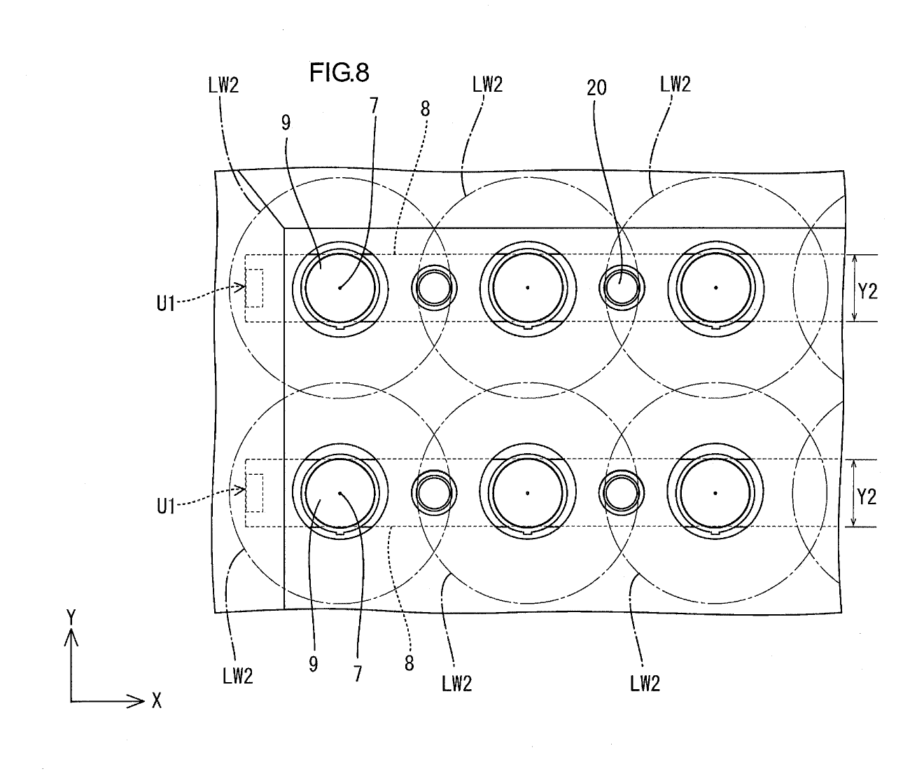

The effect obtained by the above operation is described by use of a comparative example shown in FIGS. 7 and 8. In a backlight unit 2 shown in the comparative example, the LEDs 7 (light sources) arranged on LED boards 8 are arranged with the optical axes thereof along a direction (Z-axis direction) in which light is emitted. Further, the backlight unit 2 does not include the support-portion side reflection sheets 31 of the present embodiment. Therefore, the LEDs 7 have a directivity directing light into the direction in which the light is emitted. As shown in FIG. 8, a range LW2 irradiated with light from each of the LEDs 7 has a circular shape with the LED 7 (or a diffuser lens 9) at the center in a plan view.

Each of the light source units U in the backlight unit 12 of the present embodiment is configured to emit light toward both sides thereof with respect to an arrangement direction of the lines of the light source units. This configuration enables the light source unit U to irradiate a larger range with light in a plan view than each light source unit U1 in the comparative example. Therefore, in the present embodiment, it is possible to set the arrangement intervals of the light source units U in the Y-axis direction larger than those in the comparative example, and to make the brightness even. As a result, the number of the light source units U can be reduced even in a case where even brightness distribution is required. As compared to the comparative example (FIG. 7), the backlight unit 12 of the present embodiment can reduce the number of the light source units U (the LED boards 18) to be installed therein by half, as shown in FIG. 3, in order to irradiate the same region.

Possible examples of a configuration used for reducing the number of the light source units U to be installed include a following configuration. It is the configuration in which a range irradiated with light emitted by each of the LEDs 17 is enlarged by use of the LEDs 17 having higher illuminance, which results in enlargement of the range irradiated with light from the light source units U and hence in larger arrangement intervals of the light source units U. However, this configuration results in increased heat generation of each of the LEDs 17 and hence in increased junction temperature, which invites reliability degradation (e.g., reduction of lifetime) of the LEDs 17. The present embodiment copes with this by determining the directivities of the respective light sources, thereby makes it possible to, without raising illuminance of each of the LEDs 17, enlarge the range irradiated by each of the light source units U. Thus, the above described problem of the reliability degradation of the LEDs 17 can be avoided.

In addition, it is preferable that the width of the LED board 18 is set as small as possible to reduce the material cost of the LED board 18. However, the LED boards 18 are more likely to warp when the width thereof are too small. Additionally, there may be cases where, on each of the LED boards 18, spaces to place identification information (e.g., a bar code or the like) with respect to the LED board 18, or spaces to install a structure (e.g., an attachment hole, a portion to be fitted in with others, or the like) for attachment of the LED board 18 to the chassis 14 are necessary. For the above reasons, it is necessary that the width of the LED boards 18 is larger than a certain width. In this respect, the total number of the LED boards 18 in the configuration of the present embodiment is half the number of those in the comparative example, even if a width Y1 of the LED board 18 is set to have a size sufficient to suppress the warpage of the board (or sufficient to ensure spaces to provide the identification information thereon). Thus, the present embodiment therefore makes it possible to reduce the board area of the LED boards 18 in the entire backlight unit 12. In addition, the material cost reduction is made possible. Note that, specifically, the gross area of the LED boards 18 of the entire backlight unit 12 in the present embodiment can be smaller than that in the comparative example as long as the width Y1 of the LED board 18 is made equal to or less than twice the width Y2 of each of the LED boards 8 in the comparative example.

As described above, in the backlight unit 12 in the present embodiment, the light source modules 30A and the light source modules 30B have optical directivities in opposite directions. With these two kinds of the light source modules 30 arranged on one of the LED boards 18, light is radiated toward both sides (both upward and downward in FIG. 3) of a direction along the arrangement direction of the light source units U. This makes it possible to enlarge a range irradiated with light by one light source unit, to enlarge arrangement intervals (intervals in the Y-axis direction in this embodiment) of the light source units U, and to makes brightness even, as compared to the case using the light source units U1 each including only light sources (the LEDs 7) having the same optical directivity directing light into a single direction (e.g., a direction along the direction in which light is emitted from the backlight unit 2 as shown in the comparative example of FIG. 7). As a result, the number of the light source units U can be reduced in the case where even brightness distribution is required. Consequently, the labor cost associated with the work for attaching the light source units U can be reduced as well as the material cost associated with the light source units U. Thus, significant cost reduction can be achieved as a whole.

Further, the LED boards 18 have an elongated shape, and the plurality of light source modules 30 is arranged on the LED boards 18 along the longitudinal direction of the LED boards 18. This configuration makes it possible to form the light source unit U into a linear light source, which makes it still more feasible to obtain even brightness distribution.

Further, the plurality of light source modules 30A is arranged along the longitudinal direction of the LED board 18, and the plurality of light source modules 30B is arranged parallel to the line of the light source modules 30A. In this configuration, these light source modules 30A and 30B are arranged all across the LED board 18 in the longitudinal direction thereof (the X-axis direction). Therefore, light is emitted from the light source modules 30A in lines and from the light source modules 30B in lines into different directions, respectively, whereby light is emitted into opposite directions (the first direction and a direction opposite to the first direction) in the Y-axis direction, evenly all across the LED board 18 in the longitudinal direction thereof.

Further, the light source modules 30A may be arranged with the optical axes LA1 directed in one direction (the first direction) in the Y-axis direction. This configuration allows the light source modules 30A to have an optical directivity directing light into the first direction.

Further, the light source modules 30 may include the LED 17 (the light-source body) configured to emit light, and the support-portion side reflection sheet 31 configured to reflect light emitted from the LED 17 into one direction in the Y-axis direction. With the support-portion side reflection sheet 31 thus provided, the light source module 30A is allowed, regardless of the direction of the optical axis La of the LED 17, to have an optical directivity directing light into one direction in the Y-axis direction. This makes it possible to freely determine an attaching angle formed by the LEDs 17 with respect to the LED board 18, and thereby allow a higher degree of flexibility in the step of designing the attachment structure.

Note that, although the present embodiment shows, as an example, the LED 17 as the light-source body, the light source body other than LEDs can be adopted. As long as the support-portion side reflection sheets 31 are provided as described above, it is possible to make the light source modules 30 have an optical directivity directing light into a specific direction even in a case where the light source body having a relatively low optical directivity is adopted. Therefore, kinds of light sources adoptable as the light-source body may be determined regardless of the optical directivities thereof, whereby a higher degree of flexibility in the designing step can be secured.

Further, the light source may include the LEDs 17 (light emitting diodes). This configuration allows for higher brightness, lower power consumption and the like.

Further, the lighting device may include the diffuser lenses 19 arranged so as to cover the light source modules 30 and configured to diffuse light emitted from the light source modules 30. With this configuration, light emitted from the light source modules 30 is diffused by the diffuser lenses 19. This makes it possible both to enlarge arrangement intervals of the light source modules 30 (that is, to reduce the number of the light source modules 30) and to makes brightness even. As a result, even in a case where even brightness distribution is required, the number of the light source modules 30 can be reduced as compared to a case not using the diffuser lenses 19.

### Second Embodiment

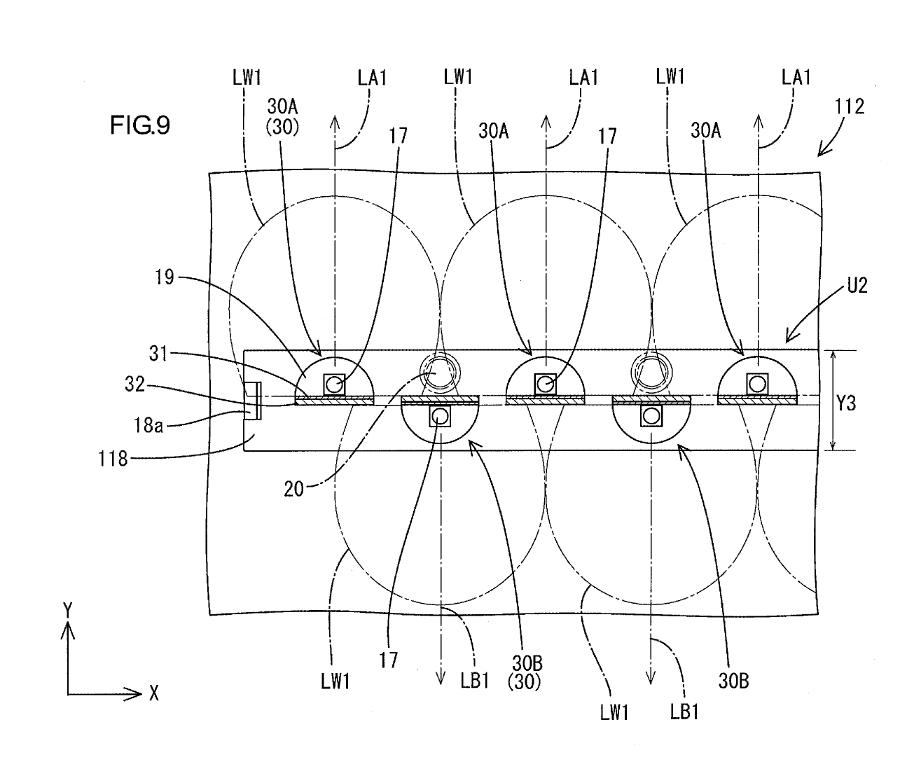

A second embodiment of the present invention is described with reference to FIG. 9. Parts identical to those of the first embodiment are denoted by the same reference signs, and redundant description is omitted. In a light source unit U2 of a backlight unit 112 of the present embodiment, the arrangement of the light source modules 30 on a LED board 118 is different from the above embodiment. Each of the light source modules 30B is arranged between two of the light source modules 30A that are adjacent to each other in the X-axis direction (the longitudinal direction of the board). An arrangement interval of the light source modules 30A that are adjacent to each other in the X-axis direction is set larger than the width of each of the light source modules 30 in the X-axis direction.

This configuration makes it unlikely that the light source modules 30A and the light source modules 30B are overlapped with each other (interfere with each other) in the Y-axis direction (a direction orthogonal to the longitudinal direction of the LED board). As a result, the light source modules 30A are arranged closer to the light source modules 30B in the Y-axis direction on the LED board 118, as shown in FIG. 9. This makes it possible to make a width Y3 of the LED board 118 smaller than, for example, the width Y1 of the LED boards 18 in the first embodiment, whereby material costs for the boards can be reduced.

### Third Embodiment

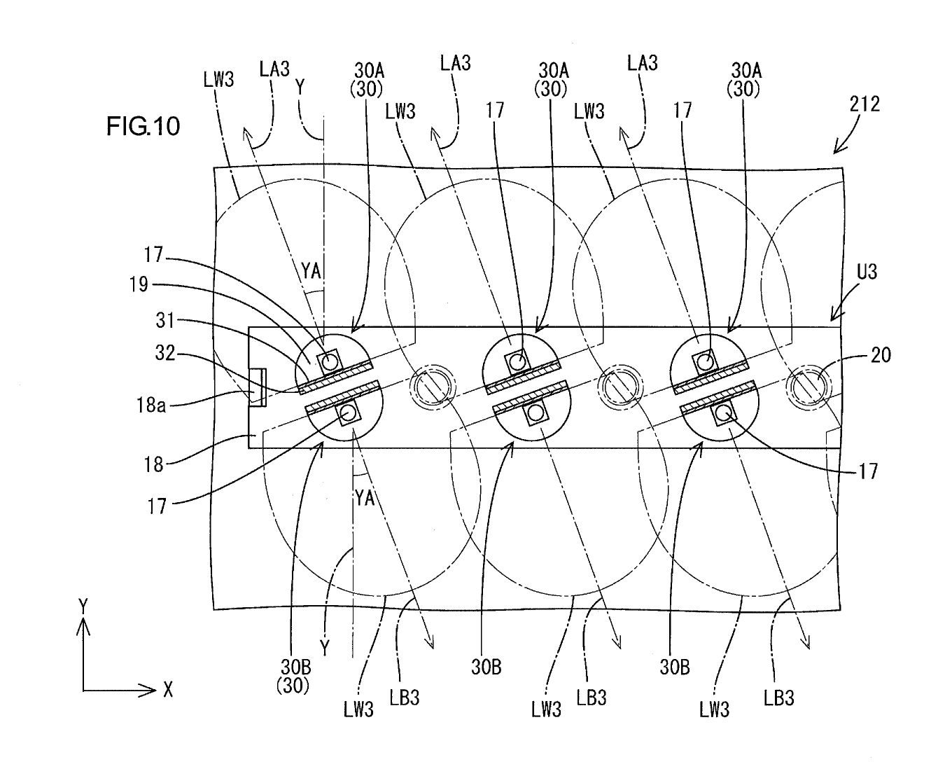

A third embodiment of the present invention is described with reference to FIG. 10. Parts identical to those of the above embodiments are denoted by the same reference signs, and redundant description is omitted. Each of the above embodiments is configured such that the light source modules 30 are installed so as to have optical directivities directing light in directions substantially aligned with the Y-axis in a plan view. In contrast, in each light source unit U3 of a backlight unit 212 in the present embodiment, the light source modules 30 arranged on the LED boards 18 are installed so as to have optical directivities directing light into directions tilted to the Y axis in a plan view.

Specifically, the light source modules 30A (the support portion 32 and the support-portion side reflection sheet 31 in particular) in the upper part in FIG. 10 are tilted leftward to the Y-axis at an angle YA in a plan view. This causes the light source modules 30A to have an optical directivity directing light into a direction (an arrow LA3; a first direction) tilted leftward to the Y axis at the angle YA. On the other hand, the light source modules 30B in the lower part in FIG. 10 have an optical directivity directing light into another direction (an arrowed line LA3; a second direction) tilted rightward to the Y-axis at the angle YA. Note that a range irradiated with light emitted from the light source modules 30 in this embodiment is schematically illustrated by use of an alternate long and short dashed line LW3. The operation and effect obtained by the above configuration is similar to those in each of the above embodiments, and description thereof is omitted.

Note that the angle YA described above can be determined as appropriate. It is only required that light source modules 30A have optical directivities directing light into directions along an arrangement direction (the Y-axis direction) of the light source units U3. In this context, “the direction along the arrangement direction” maybe a direction substantially the same as the arrangement direction, and may be a direction tilted to some extent to the arrangement direction (Y axis direction in this context). Additionally, it is only required that the light source modules 30B have an optical directivity directing light into a direction opposite to the direction (the first direction) corresponding to the optical directivity of the light source module 30A. “A direction opposite to the first direction” used in this context is not limited to one obtained by turning the first direction by 180 degrees, and may have a certain amount of tilt to the thus obtained direction. Further, the angle YA described above may be set to a different value with respect to each of the light source modules 30.

### Fourth Embodiment

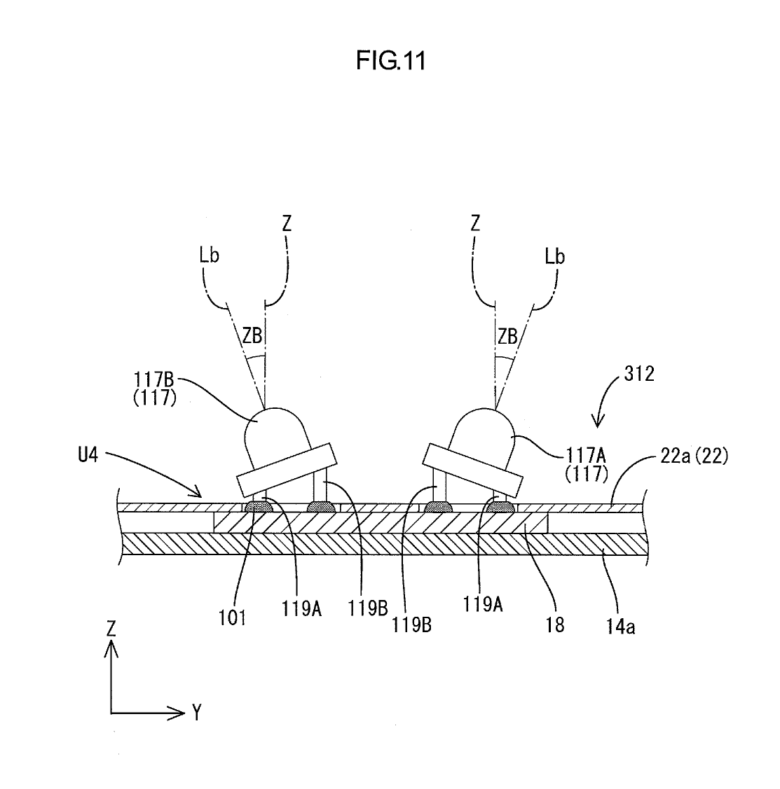

A fourth embodiment of the present invention is described with reference to FIG. 11. Parts identical to those of the above embodiments are denoted by the same reference signs, and redundant description is omitted. Each of the above embodiments shows, as an example, the light source modules 30 as the light sources. That is, with the configuration of each of the above embodiments, light from the LEDs 17 is reflected by the support-portion side reflection sheets 31, whereby the light source modules 30 are allowed to have optical directivities directing light into directions along the Y-axis direction. In contrast, each light source unit U4 of a backlight unit 312 in this embodiment is configured so as to, with LEDs 117 (light sources) being tilted to the Z axis, have optical directivities directing light into directions along the Y-axis direction in a plan view.

As shown in FIG. 11, in each of the LEDs 117 of the present embodiment, two terminals 119 (an anode and a cathode) projecting from the bottom surface of the LED 117 are provided. The length of one terminal 119B is set larger than the length of the other terminal 119A. This makes the optical axis Lb of the LED 117 tilted to the Z-axis (indicated by a tilt angle ZB to the Z axis) when the LED 117 is mounted on the LED board 18 with a solder portion 101 interposed therebetween. In addition, the optical axes Lb of the LED 117 (a first light source, denoted by a reference sign 117A) in the right side in FIG. 11 and the LED 117 (a second light source, denoted by a reference sign 117A) in the left side therein are tilted toward opposite directions. Note that the tilt angle ZB may be set as appropriate, and may be set to a different value with respect to each of the LEDs 117.

With this configuration, the optical axis Lb of the LED 117A is arranged to face one side (a first direction) in the Y-axis direction in a plan view, whereas the optical axis Lb of the LED 117B is arranged to face the other side (a second direction) in the Y-axis direction in a plan view. The operation and effect obtained by this configuration is the same as the operation and effect in each of the embodiments described above, and description thereof is omitted. In addition, with a relatively simple configuration having the LEDs 117 arranged in a tilted manner, the present embodiment allows the light sources to have optical directivities directing light into directions along the Y-axis direction. Note that this embodiment may include the diffuser lenses 19 so as to cover the front side of the LEDs 117.

### Fifth Embodiment

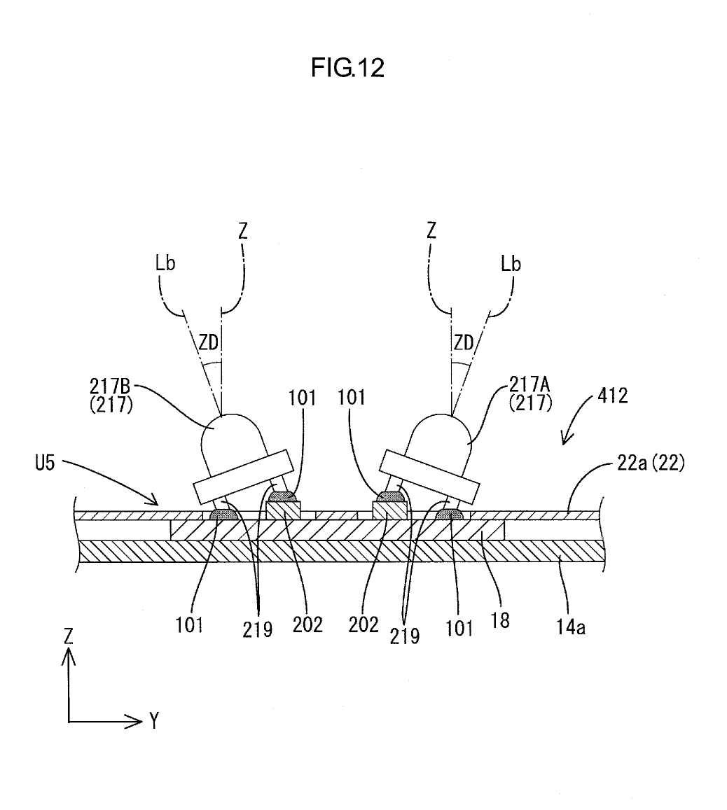

A fifth embodiment of the present invention is described with reference to FIG. 12. Parts identical to those of the above embodiments are denoted by the same reference signs, and redundant description is omitted. The fourth embodiment is configured such that, with the two terminals in each of the LEDs 117 being formed in different length, the LEDs 117 are tilted. However, in the fifth embodiment, in each LED 217 of a backlight unit 412, while the length of two terminals 219 are the same, one of the terminals 219 is mounted on the LED board 18 with a spacer member 202 therebetween, the spacer member 202 having a substantially box-like shape. With this configuration, the LED 217 is mounted with the optical axis Ld of the LED 217 being tilted to the Z-axis (indicated by a tilt angle ZD to the Z axis). This configuration allows the LED 217 as a light source to have optical directivities directing light in directions along the Y-axis direction. Further, this configuration makes it possible to change the tilt angle ZD of the optical axis Ld of the LED 217 only by changing the height of the spacer member 202. Instead of using the spacer member 202, a thermosetting conductive adhesive may be formed in a paste having a given thickness (height). This embodiment may be configured such that the optical axis Ld is tilted by having one of the terminals 219 mounted on the LED board 18 with this conductive adhesive paste therebetween.

### Other Embodiment

The present invention is not limited to the above embodiments explained in the above description. The following embodiments may be included in the technical scope of the present invention, for example.

(1) Each of the above embodiments shows, as an example, the configuration that allows a light source to have an optical directivity directing light into a direction along the Y-axis direction by providing the support-portion side reflection sheets 31 or the configuration that have the LEDs tilted. However, the present invention is not limited to these configurations. Basically, as long as the light source is allowed to have an optical directivity directing light into a direction along the Y-axis direction in a plan view, any configuration may be used for providing the optical directivity.

(2) The first embodiment described above shows, as examples, the light source modules 30A as the first light sources, and the light source modules 30B as the second light sources. However, another configuration obtained by replacing these two kinds of light source modules with each other may be used. The light source modules 30B may be provided as the first light sources, and the light source modules 30A may be provided as the second light sources.

(3) Each of the above embodiments shows, as an example, the support-portion side reflection sheet 31 as the reflection portion. However, the present invention is not limited thereto. For example, the reflection portion may be formed on the entire surface of the support portion 32 by printing with the paste that contains a metal oxide.

(4) The shape, material and the like of the diffuser lenses 19 are not limited to those described in the above embodiments. It is only required that the diffuser lenses 19 have the function of diffusing light.

(5) Each of the above embodiments shows, as an example, a configuration using the LEDs 17 as light sources. However, another configuration using light sources other than LEDs may be used.

(6) The above described embodiments show, as an example, a case where the liquid crystal panel and the chassis are provided in the stand-up state with the short side direction thereof aligned with the vertical direction. However, the present invention also includes a case where the liquid crystal panel and the chassis are set in the stand-up state with the long side direction thereof aligned with the vertical direction.

(7) The above described embodiments use TFTs as switching components of the liquid crystal display device. However, the present invention is also applicable to a liquid crystal display device using switching components other than TFTs (e.g., thin-film diodes (TFDs)), and also applicable to not only liquid crystal display devices providing color display but also liquid crystal display devices providing monochrome display.

(8) The above described embodiments show, as an example, the liquid crystal display device using a liquid crystal panel as a display panel. However, the present invention is applicable also to a display device using other types of display panel.

(9) The above described embodiments show, as an example, the television receiver including a tuner. However, the present invention is applicable also to a display device that does not include a tuner.

(10) The above described embodiments show, as an example, a configuration having each of the LED boards 18 arranged with the longitudinal direction thereof along the X-axis direction. However, the present invention is not limited thereto. For example, the linear light source may be formed by having each of the LED boards 18 arranged with the longitudinal direction thereof along the Y-axis direction.

1. A lighting device comprising a plurality of light source units arranged parallel to each other, each unit including a plurality of light sources arranged on a board, the plurality of light sources on the board including
first light sources having an optical directivity directing light therefrom into a first direction in a plan view, the first direction being along an arrangement direction of the light source units, and
second light sources having an optical directivity directing light therefrom into a second direction opposite to the first direction in a plan view.

2. The lighting device according to claim 1, wherein
the board has an elongated shape, and
the plurality of light sources are arranged on the board along the longitudinal direction of the board.

3. The lighting device according to claim 2, wherein
the first light sources are arranged along the longitudinal direction of the board, and
the second light sources are arranged along a line in which the first light sources are arranged.

4. The lighting device according to claim 2, wherein each of the second light sources is arranged in a space between the first light sources that are adjacent to each other in the longitudinal direction of the board.

5. The lighting device according to claim 1, wherein the first light sources are arranged with optical axes thereof aligned with the first direction in a plan view.

6. The lighting device according to claim 1, wherein each of the first light sources includes
a light-source body configured to emit light, and
a reflection portion configured to reflect light emitted from the light-source body into the first direction.

7. The lighting device according to claim 1, wherein each of the light sources includes a light emitting diode.

8. The lighting device according to claim 1, further comprising diffuser lenses arranged so as to cover the light sources, and configured to diffuse light emitted from the light sources.

9. A display device comprising:
the lighting device according to claims 1; and
a display panel configured to provide display using light emitted from the lighting device.

10. The display device according to claim 9, wherein the display panel is a liquid crystal panel using liquid crystals.

11. A television receiver comprising the display device according to claim 9.
